(19) United States
(12) Patent Application Publication
(10) Pub. No.: US 2006/0070036 A1
(43) Pub. Date: Mar. 30, 2006

(54) Adapting the demonstration of a program execution without modifying the program code by providing application hooks in the program to display user selected images

(75) Inventors: David E. Cox, Raleigh, NC (US); Craig M. Lawton, Raleigh, NC (US); Jonathan A. Lewis, Morrisville, NC (US); Christopher A. Peters, Round Rock, TX (US); Lorin E. Ullmann, Austin, TX (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 10/955,185

(22) Filed: Sep. 30, 2004

(51) Int. Cl. G06F 9/44

(52) U.S. Cl. 717/124; 717/130

(57) ABSTRACT

A method, computer program product and system for displaying images during the execution of an application. A developer of an application inserts application hooks at particular locations in the code of the application to be executed. An application hook could be a call to a function in a utility code where the call includes the passing of a “key name”. The called function may retrieve an image located at an image file name in a configuration file associated with the key name if such an image file exists. Presentations that demonstrate the execution of the application may be easily modified by adding, deleting or replacing images at these file names. These modifications may be made without modifying the code of the application being executed. In this manner, different images used in different presentations may be displayed to different targeted audiences without modifying the code of the executed application.

### TECHNICAL FIELD

The present invention relates to the field of demonstrating programs, and more particularly to adapting the demonstration of a program execution without modifying the program by providing application hooks in the program to display user selected images.

### BACKGROUND INFORMATION

Software programs, such as installer programs, may need to be demonstrated to potential customers. Demonstration, as used herein, refers to displaying images to potential customers that indicate information, such as the status, of the program being executed. For example, when an installer program installs an application program onto a computer, the installer program may provide images that displays the status of the installation, e.g., an image is displayed to indicate when there is a failure in the installation.

However, it may be desirable to display a different set of images regarding the execution of a software application for different potential customers. For example, a presenter may desire to display a different set of images to different automobile manufacturers during the execution of a software application that is used in the automobile industry. Currently, if the presenter wants to present a different set of images to a different customer, the presenter has to modify the code of the application being demonstrated such as by modifying the code directed to displaying images. However, the presenter must be careful in modifying the code as the presenter does not want to impair the application in the process. Further, once the presenter modifies the program code to display a new set of images, the presenter would have to modify the program code again to present the same earlier presentation. Further, the application could not be currently executing while the presenter selects a different set of images to be displayed. That is, the presenter cannot update images shown during the execution of the program. Hence, it is time consuming and difficult in designing different presentations of an application program during execution for different potential customers.

Therefore, there is a need in the art for a presenter to be able to create multiple demonstrations for different potential customers of a software program that does not require modifications to the code of the software program. Further, there is a need in the art to be able to update images shown during the execution of an application program, such as during a demonstration of the application, and that the images displayed can be modified without the need for modifying the code of the application.

### SUMMARY

The problems outlined above may at least in part be solved in some embodiments by inserting application hooks in the code of the application to be executed. During the execution of the application, these application hooks may call a function in a utility code to retrieve images stored in a configuration file separate from the application being executed. Different images may be located at different file names stored in a directory in the configuration file. Presentations that demonstrate the execution of the application may be easily modified by adding, deleting or replacing images at these file names. These modifications may be made without modifying the code of the application being executed. Further, these images may be updated during the execution of the application. A more detailed description of modifying presentations is described herein.

In one embodiment of the present invention, a method for selectively displaying images during the execution of an application may comprise the step of inserting multiple application hooks at appropriate locations in the code of the application where the application hooks identify respective ones of multiple images in a configuration file. The method may further comprise executing the application. The method may further comprise executing an application hook to call the function. The method may further comprise retrieving a selected image at a file name from the configuration file responsive to the application hook during the execution of the application. The method may further comprise displaying the retrieved image during the execution of the application.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of an installer program, a utility code and a configuration file; and

FIG. 3 is a flowchart of a method for displaying images during the execution of an application in accordance with an embodiment of the present invention.

### DETAILED DESCRIPTION

The present invention comprises a method, computer program product and system for displaying images during the execution of an application. In one embodiment of the present invention, a developer of an application inserts application hooks at particular locations in the code of the application to be executed. An application hook could be a call to a function in a utility code where the call includes the passing of a “key name”. The called function may determine if there exists an image file name in a configuration file associated with the passed key name. If so, then the called function retrieves the image located at the image file name associated with the passed key name. Different images may be located at different file names stored in a directory in the configuration file. Presentations that demonstrate the execution of the application may be easily modified by adding, deleting or replacing images at these file names. These modifications may be made without modifying the code of the application being executed. Further, these images may be updated during the execution of the application. In another embodiment, different sets of images, which may be used for different presentations, may be stored in separate directories in the configuration file. In this embodiment, the application hook may pass the file name to the called function which may then retrieve the appropriate image from the appropriate directory in the configuration file.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

Although the present invention is described with reference to an installer program, it is noted that the principles of the present invention may be applied to any type of application, e.g., database application, teaching tool, that involves demonstrating multiple sets of images for different targeted audiences. It is further noted that embodiments applying the principles of the present invention to such applications would fall within the scope of the present invention.

It is further noted that although the present invention is described with reference to presenting demonstrations that the principles of the present invention may be applied to any application in which images need to be updated during the execution of an application program and that the images displayed can be modified without the need for modifying the code of the application. It is further noted that embodiments applying the principles of the present invention to such applications would fall within the scope of the present invention.

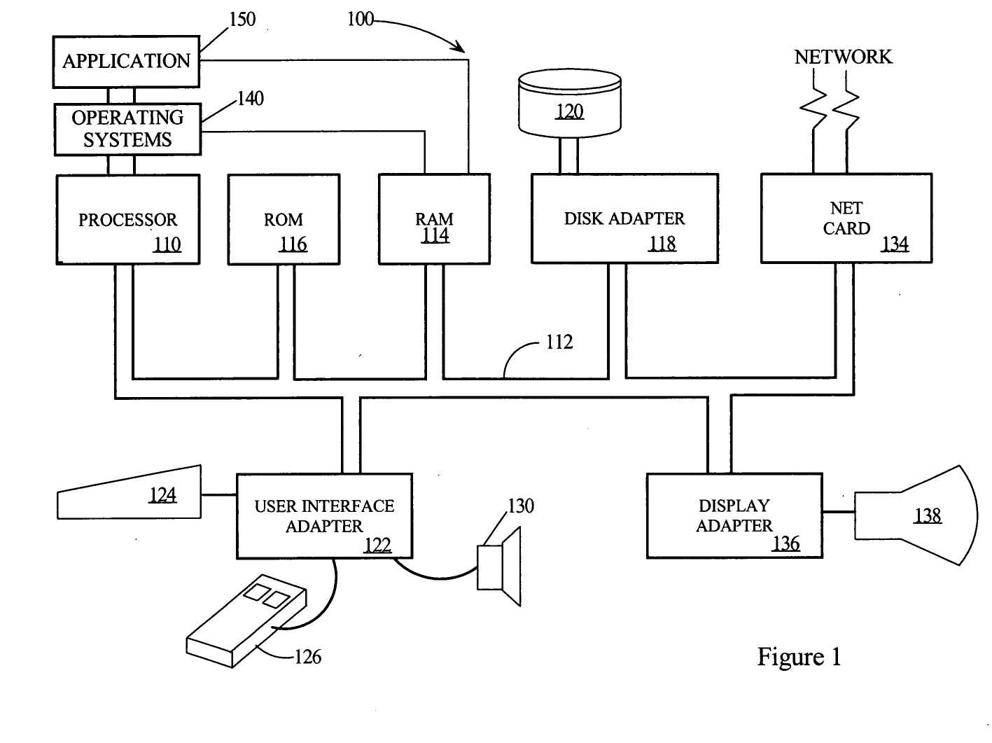

FIG. 1—Computer System

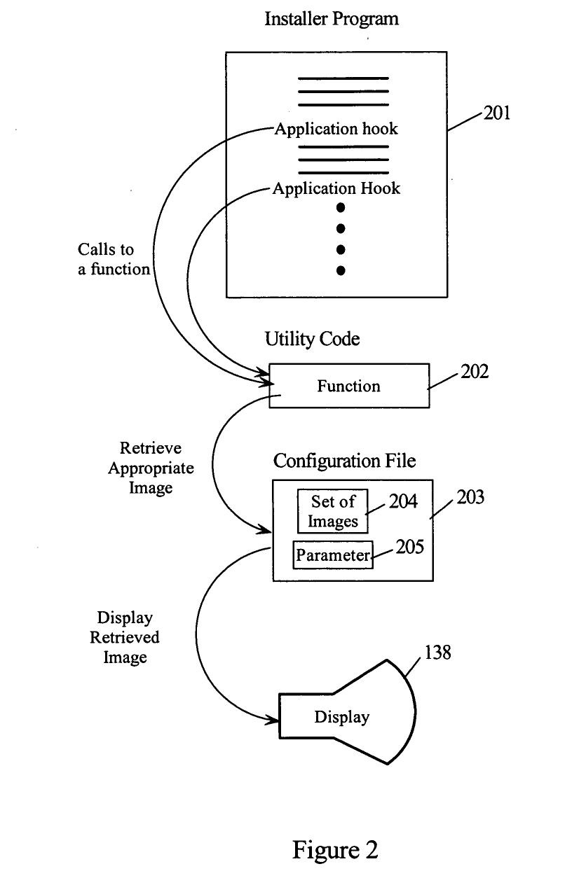

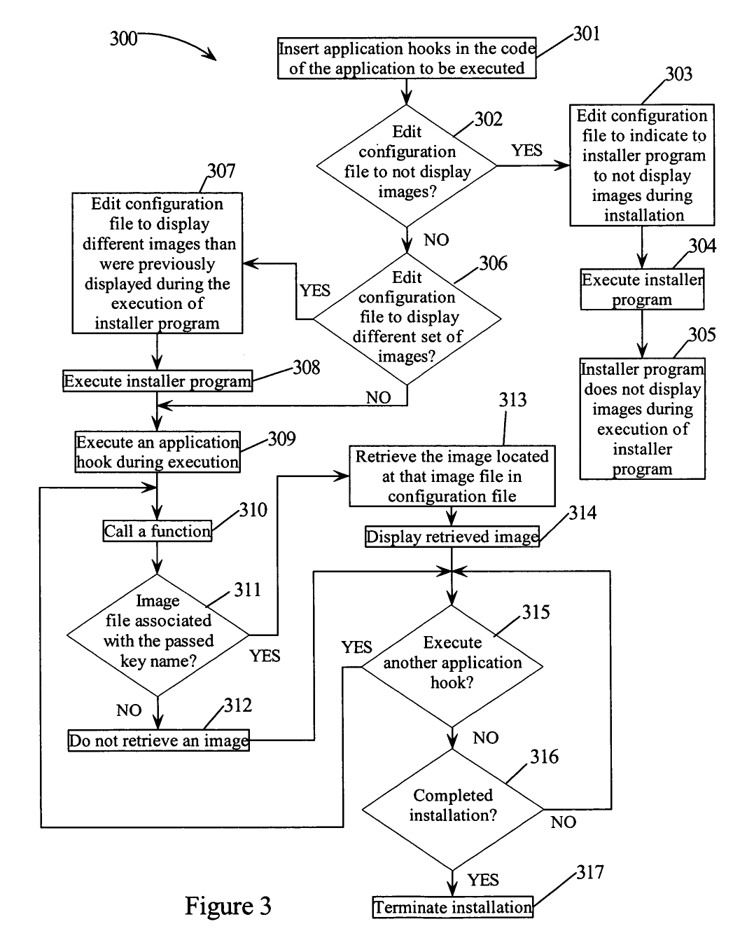

FIG. 1 illustrates a typical hardware configuration of computer system 100 which is representative of a hardware environment for practicing the present invention. Computer system 100 may have a processor 110 coupled to various other components by system bus 112. An operating system 140 may run on processor 110 and provide control and coordinate the functions of the various components of FIG. 1. An application 150 in accordance with the principles of the present invention may run in conjunction with operating system 140 and provide calls to operating system 140 where the calls implement the various functions or services to be performed by application 150. Application 150 may include, for example, an installer program, e.g., Platform Installation and Configuration Service (PICS), containing application hooks configured to call a function used to retrieve an appropriate image to be displayed as discussed further below in association with FIGS. 2-3. A more detail description of the installer program is provided below in association with FIG. 2. FIG. 3 is a flowchart of a method for displaying images during the execution of an application. Application 150 may further include a utility code containing functions used to retrieve the appropriate images to be displayed. A more detailed description of the utility code is provided below in association with FIG. 2. Application 150 may further include a configuration file used to store the files containing the images to be retrieved and displayed. A more detailed description of the configuration file is provided below in association with FIG. 2.

Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software components including operating system 140 and application 150 may be loaded into RAM 114 which may be computer system's 100 main memory for execution. Disk adapter 118 may be an integrated drive electronics (“IDE”) adapter that communicates with a disk unit 120, e.g., disk drive. It is noted that the installer program containing application hooks configured to call a function used to retrieve an appropriate image to be displayed, as discussed in association with FIGS. 2-3, may reside in disk unit 120 or in application 150. It is further noted that the utility code and the configuration file, as discussed in association with FIGS. 2-3, may reside in disk unit 120 or in application 150.

Referring to FIG. 1, computer system 100 may further comprise a network card 134 coupled to bus 112. Network card 134 may interconnect bus 112 with an outside network, e.g., Local Area Network (LAN), Wide Area Network (WAN), enabling computer system 100 to communicate with other such systems. I/O devices may also be connected to system bus 112 via a user interface adapter 122 and a display adapter 136. Keyboard 124, mouse 126 and speaker 130 may all be interconnected to bus 112 through user interface adapter 122. Data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138 or speaker 130. For example, a user may be capable of entering commands via a command line interface or a graphical user interface on display 138 via keyboard 124 or mouse 126.

Implementations of the invention include implementations as a computer system programmed to execute the method or methods described herein, and as a computer program product. According to the computer system implementations, sets of instructions for executing the method or methods may be resident in the random access memory 114 of one or more computer systems configured generally as described above. Until required by computer system 100, the set of instructions may be stored as a computer program product in another computer memory, for example, in disk unit 120. Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 2—Installer Program, Utility Code and Configuration File

FIG. 2 illustrates an embodiment of the present invention of an installer program 201 (referring to the installer program that may reside in either application 150 or in disk unit 120 as illustrated in FIG. 1), a utility code 202 and a configuration file 203. Referring to FIG. 2, installer program 201 may include code used to install a software application. For example, the code may include instructions to installer program 201 to perform particular steps, e.g., detect installed middleware, check for compatibility, determine middleware ownership, check for conflicts, install new instance or reuse existing instance, validate installation(s) and provide details to product, during the installation process. During the installation process, images may be displayed to the user, such as in a companion window on display 138 (FIG. 1), when installer program 201 encounters an application hook. A companion window may refer to an accompanying window that is displayed along with a window for the installed application. In another embodiment, the images may be displayed in the same window as the installed application. An application hook may refer to an instruction that calls an outside routine or function. These application hooks are placed in the code at appropriate locations in order to display the appropriate image at the appropriate moment during the installation process.

Upon installer program 201 encountering an application hook during execution of installer program 201, a call is made to a function, designated by the encountered application hook, in utility code 202. In one embodiment, when the application hooks calls a function in utility code 202, the application hook may pass a pointer, referred to herein as a “key name”, to the called function in utility code 202. In one embodiment, utility code 202 may reside in a Java ARchive (JAR) file. The called function may then search configuration file 203 for an image file name that is associated with the key name. If the called function locates an image file name that is associated with the key name, then the called function retrieves the image located at that file name from configuration file 203. Configuration file 203 may store a set of images 204, such as in a directory. The called function retrieves the appropriate image from this set of images 204 to be displayed on display 138. In one embodiment, one or more images retrieved from the set of images 204 are displayed in a companion window on display 138. In another embodiment, one or more images retrieved from the set of images 204 are displayed in the same window as the installed application. In one embodiment, the set of images 204 is a log file such as a trace or message file.

For example, suppose installer program 201 contained hooks to load the following set of images in a directory in configuration file 203.
DIRECTORY=C:\Program Files\Images\
START=start.gif
FIRST_OP=beforetask1.gif
SECOND_OP=aftertask1.gif
THIRD_OP=beforetask2.gif
FOURTH_OP=aftertask2.gif
FIFTH_OP=beforetask3.gif
SIXTH_OP=aftertask3.gif
SEVENTH_OP=end.gif

Upon encountering the first hook, a call, e.g., “utility.displayImage(START)”, is made to an appropriate function in utility code 202 which includes the passing of a key name, e.g., “START”. The called utility function may then retrieve the image file, e.g., “start.gif”, in configuration file 203 that is associated with the key name. If there is no image file associated with the passed key name, then no image is displayed on display 138. If, however, an image file is associated with the passed key name, then the image at that location is displayed at display 138. Installer program 201 continues with its installation and eventually encounters the second hook. A call is then made to an appropriate function in utility code 202 which includes the passing of a second key name “FIRST_OP.” If no image file is associated with this passed key name, then the current image being displayed on display 138 remains displayed. If, however, an image file is associated with this passed key name, then the image located at that file name, e.g., beforetask1.gif, replaces the current image being displayed on display 138. The above outlined process continues until the termination of the installation process.

As stated in the Background Information, it may be desirable to display a different set of images regarding the execution of a software application for different potential customers. For example, a presenter may desire to display a different set of images to different automobile manufacturers during the execution of a software application that is used in the automobile industry. Currently, if the presenter wants to present a different set of images to a different customer, the presenter has to modify the code of the application being demonstrated such as by modifying the code directed to displaying images. Hence, it is time consuming and difficult in designing different presentations of an application program during execution for different potential customers. Therefore, there is a need in the art for a presenter to be able to create multiple demonstrations for different potential customers of a software program that does not require modifications to the code of the software program. Further, there is a need in the art to be able to update images shown during the execution of an application program, such as during a demonstration of the application, and that the images displayed can be modified without the need for modifying the code of the application.

Multiple demonstrations may be created with ease in one embodiment by adding, replacing or deleting images in the directory of configuration file 203. For example, suppose at c:\program files\images\start.gif, there is no image currently. If the presenter desires to have an image at this point during the installation process for a particular targeted audience, then the presenter may insert an image at that location. Conversely, suppose at c:\program files\images\start.gif, there exists an image currently. If the presenter desires to not have an image at this point during the installation process for a particular targeted audience, then the presenter may remove the image at that location. Alternatively, if the presenter desires to have a different image at this point during the installation process for a particular targeted audience, then the presenter may replace the image with a new image at that location. In this manner, creating multiple presentations for different targeted audiences may be done with ease without modifying the code of the application, e.g., installer program 201. That is, images to be displayed during execution of an application program, e.g., installer program 201, may be updated without modifying the code of the application program.

In another embodiment, each presentation for a particular targeted audience may be stored in a unique directory in configuration file 203. For example, each set of images may be stored in a unique directory. In this embodiment, the application hook may pass the file name to the called function which may then retrieve the appropriate image from the appropriate directory in configuration file 203. In this manner, creating multiple presentations for different targeted audiences may be done with ease without modifying the code of the application, e.g., installer program 201. That is, images to be displayed during execution of an application program, e.g., installer program 201, may be updated without modifying the code of the application program.

In one embodiment, configuration file 203 may further include a parameter 205 that can be set to a certain value, e.g., zero, that prevents the called function in utility code 202 from retrieving any images from configuration file 203. In this manner, a presenter may be able to turn on and off the ability to display images, such as a visual log, during the execution of an application, e.g., installer program 201.

In one embodiment, configuration file 203 may further be configured to indicate where an image is to be displayed. For example, configuration file 203 may indicate that a particular image is to be displayed in a companion window or in the window for the installed application.

A more detailed description of displaying different sets of images for different targeted audiences without modifying the code of the application is described below in association with FIG. 3.

FIG. 3—Method for Displaying Images During the Execution of an Application

FIG. 3 is a flowchart of one embodiment of the present invention of a method 300 for displaying images during the execution of an application, e.g., installer program 201 (FIG. 2).

Referring to FIG. 3, in conjunction with FIGS. 1-2, in step 301, the developer inserts application hooks in particular locations in the code of the application to be executed, e.g., installer program 201. As stated above, the application hooks may be configured to call a function in utility code 202 used to retrieve an appropriate image from configuration file 203. It is noted that even though the description below describes the executed application as installer program 201 that the executed application may be any type of application, e.g., database application, teaching tool, that displays images during its execution.

In step 302, a determination is made by the presenter as to whether to edit configuration file 203 to not display images during the execution of installer program 201.

If the presenter determines not to display images during the execution of installer program 201, then, in step 303, the presenter edits configuration file 203 to not display any images during the execution of installer program 201. In one embodiment, the presenter may set a parameter in configuration file 203 to a value, e.g., zero, to indicate to not display any images during the execution of installer program 201. Upon the encountered application hook calling the function in utility code 202, the function would be prevented from retrieving the image from configuration file 203.

In step 304, installer program 201 is executed to install an application. In step 305, installer program 201 does not display any images during the execution of installer program 201.

Referring to step 302, if the presenter determines to display images during the execution of installer program 201, then, in step 306, the presenter determines whether to edit configuration file 203 to display different images than were previously displayed during the execution of installer program 201.

If the presenter determines to edit configuration file 203 to display different images than were previously displayed during the execution of installer program 201 then, in step 307, the presenter edits configuration file 203 to display different images than were previously displayed during the execution of installer program 201. For example, the presenter may insert, modify or delete images at particular file locations stored in configuration file 203 without modifying the code of installer program 201 as explained above. In another example, the presenter may store a set of images for the current targeted audience in a unique directory in configuration 203. In this embodiment, the application hook may pass the file name to the called function which may then retrieve the appropriate function from the appropriate directory in configuration file 203. A more detail description of displaying different images than were previously displayed during the execution of installer program 201 is provided above and will not be restated for the sake of brevity.

Upon editing configuration file 203 to display different images than were previously displayed during the execution of installer program 201, installer program 201 is executed to install an application in step 308.

In step 309, installer program 201 executes an application hook during its execution. In step 310, the encountered application hook calls a function in utility code 202. In one embodiment, the application hook passes a key name in its call to the function. In another embodiment, the application hook may pass a file name to the called function to retrieve an appropriate image from an appropriate directory in configuration file 203 as described above. It is noted that while the description below describes displaying images during the execution of an application, e.g., installer program 201, using the embodiment of the application hook passing a key name that the principles of the present invention outlined below apply to the embodiment of the application hook passing a file name.

In step 311, the called function determines if an image file is associated with the passed key name. If there is no image file associated with the passed key name, then, in step 312, the called function does not retrieve an image from configuration file 203 to be displayed on display 138. Accordingly, the image currently being displayed on display 138 remains displayed. It is noted that if no image is currently being displayed on display 138 (in one embodiment referring to the companion window on display 138 and in another embodiment referring to the window for the installed application) then until an image is retrieved from configuration file 203 there will still be no image displayed on display 138.

If, however, an image file, e.g., c:\program files\images\start.gif, is associated with the passed key name, then, in step 313, the called function retrieves the image located at that file name, e.g., c:\program files\images\start.gif, from configuration file 203. Upon retrieving the image from configuration file 203, the retrieved image is displayed on display 138 in step 314. For example, the image currently being displayed in a companion window on display 138 may be updated with the retrieved image such as by replacing the current image with the retrieved image.

Upon execution of step 312 or step 314, installer program 201 makes a determination, in step 315, as to whether it encountered another application hook during its execution to be executed. If installer program 201 has not currently encountered another application hook, then, in step 316, installer program 201 makes a determination as to whether it has completed its software installation.

If installer program 201 has not completed its software installation, then installer program 201 makes a determination as to whether it executes another application hook during its execution in step 315. If, however, installer program 201 has completed its software installation, then, in step 317, the installation is terminated.

If, however, installer program 201 has encountered and executed another application hook, then the executed application hook calls a function in utility code 202 in step 310.

Referring to step 306, if the presenter determines to display the same images that were previously displayed during the execution of installer program 201, then installer program 201 is executed to install an application in step 308.

It is noted that method 300 may include other and/or additional steps that, for clarity, are not depicted. It is further noted that method 300 may be executed in a different order presented and that the order presented in the discussion of FIG. 3 is illustrative. It is further noted that certain steps in method 300 may be executed in a substantially simultaneous manner.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for selectively displaying images during the execution of an application comprising the steps of:
inserting multiple application hooks at appropriate locations in the code of said application, wherein said application hooks identify respective ones of multiple images in a configuration file;
executing said application;
executing a first application hook to call said function;
retrieving a selected first image located at a first file name from said configuration file responsive to said first application hook during said execution of said application; and
displaying said retrieved first image during said execution of said application.

2. The method as recited in claim 1, wherein said retrieved first image replaces a second image being displayed.

3. The method as recited in claim 1 further comprising the step of:
editing said configuration file to not display images during said execution of said application.

4. The method as recited in claim 1 further comprising the step of:
editing said configuration file to display a second image in addition to displaying said first image during said execution of said application by adding said second image to said configuration file.

5. The method as recited in claim 1 further comprising the step of:
editing said configuration file to display a second image and not display said first image during said execution of said application by replacing said second image with said first image in said configuration file.

6. The method as recited in claim 1 further comprising the step of:
editing said configuration file to not display said first image during said execution of said application by deleting said first image from said configuration file.

7. The method as recited in claim 1, wherein said configuration file comprises a plurality of directories where each of said plurality of directories comprises a unique set of images.

8. The method as recited in claim 7 further comprising the step of:
passing said first file name to said called function to retrieve said first image located at said passed file name from a selected one of said plurality of directories.

9. The method as recited in claim 1 further comprising the step of:
passing a key name to said called function to retrieve said first image located at said first file name associated with said key name.

10. The method as recited in claim 1, wherein said first image is an image from a log file.

11. A computer program product embodied in a machine readable medium for selectively displaying images during the execution of an application comprising the programming steps of:
executing an application, wherein said application contains multiple application hooks inserted at appropriate locations in the code of said application, wherein said application hooks identify respective ones of multiple images in a configuration file;
executing a first application hook to call said function;
retrieving a selected first image located at a first file name from said configuration file responsive to said first application hook during said execution of said application; and
displaying said retrieved first image during said execution of said application.

12. The computer program product as recited in claim 11, wherein said retrieved first image replaces a second image being displayed.

13. The computer program product as recited in claim 11, wherein said configuration file is edited to further comprising the programming step of:
editing said configuration file to not display images during said execution of said application.

14. The computer program product as recited in claim 11 further comprising the programming step of:
editing said configuration file to display a second image in addition to displaying said first image during said execution of said application by adding said second image to said configuration file.

15. The computer program product as recited in claim 11 further comprising the programming step of:
editing said configuration file to display a second image and not display said first image during said execution of said application by replacing said second image with said first image in said configuration file.

16. The computer program product as recited in claim 11 further comprising the programming step of:
editing said configuration file to not display said first image during said execution of said application by deleting said first image from said configuration file.

17. The computer program product as recited in claim 11, wherein said configuration file comprises a plurality of directories where each of said plurality of directories comprises a unique set of images.

18. The computer program product as recited in claim 17 further comprising the programming step of:
passing said first file name to said called function to retrieve said first image located at said passed file name from a selected one of said plurality of directories.

19. The computer program product as recited in claim 11 further comprising the programming step of:
passing a key name to said called function to retrieve said first image located at said first file name associated with said key name.

20. The computer program product as recited in claim 11, wherein said first image is an image from a log file.

21. A system, comprising:
a processor; and
a memory unit coupled to said processor, wherein said memory unit is operable for storing a computer program for selectively displaying images during the execution of an application;
wherein said processor, responsive to said computer program, comprises:
circuitry for executing an application, wherein said application contains multiple application hooks inserted at appropriate locations in the code of said application, wherein said application hooks identify respective ones of multiple images in a configuration file;
circuitry for executing a first application hook to call said function;
circuitry for retrieving a selected first image located at a first file name from said configuration file responsive to said first application hook during said execution of said application; and
circuitry for displaying said retrieved first image during said execution of said application.

22. The system as recited in claim 21, wherein said retrieved first image replaces a second image being displayed.

23. The system as recited in claim 21, wherein said processor further comprises:
circuitry for editing said configuration file to not display images during said execution of said application.

24. The system as recited in claim 21, wherein said processor further comprises:
circuitry for editing said configuration file to display a second image in addition to displaying said first image during said execution of said application by adding said second image to said configuration file.

25. The system as recited in claim 21, wherein said processor further comprises:
circuitry for editing said configuration file to display a second image and not display said first image during said execution of said application by replacing said second image with said first image in said configuration file.

26. The system as recited in claim 21, wherein said processor further comprises:
circuitry for editing said configuration file to not display said first image during said execution of said application by deleting said first image from said configuration file.

27. The system as recited in claim 21, wherein said configuration file comprises a plurality of directories where each of said plurality of directories comprises a unique set of images.

28. The system as recited in claim 27, wherein said processor further comprises:
circuitry for passing said first file name to said called function to retrieve said first image located at said passed file name from a selected one of said plurality of directories.

29. The system as recited in claim 21, wherein said processor further comprises:
circuitry for passing a key name to said called function to retrieve said first image located at said first file name associated with said key name.

30. The system as recited in claim 21, wherein said first image is an image from a log file.
